(19) United States
(12) Patent Application Publication
(10) Pub. No.: US 2018/0161931 A1
(43) Pub. Date: Jun. 14, 2018

(54) JOINING METALLURGICALLY INCOMPATIBLE METALS

(71) Applicant: The Curators of the University of Missouri, Columbia, MO (US)

(72) Inventors: Wei Li, Rolla, MO (US); Frank Liou, Rolla, MO (US)

(73) Assignee: The Curators of the University of Missouri, Columbia, MO (US)

(21) Appl. No.: 15/812,740

(22) Filed: Nov. 14, 2017

Related U.S. Application Data
(60) Provisional application No. 62/431,501, filed on Dec. 8, 2016.

(51) Int. Cl. B23K 26/211; B22F 7/08; B23K 26/323; B23K 1/005

(52) U.S. Cl. CPC B23K 26/211; B22F 7/08; B22F 2301/205; B23K 1/0056; B22F 2301/35; B23K 26/323

(57) ABSTRACT

A method for joining a second alloy material to a first alloy material where the two alloy materials are incompatible, comprising forming three successive interface layers over a substrate comprising the first alloy material, followed by forming a structure of the second alloy material over the interface layers, wherein the composition and deposition method for each of the layers is selected so that brittle intermetallics are not formed between elements of the adjacent layer compositions.

### REFERENCE TO RELATED APPLICATION

This application claims priority to U.S. provisional application 62/431,501, filed Dec. 21, 2016, the entire disclosure of which is incorporated herein by reference.

### STATEMENT OF GOVERNMENT INTEREST

This invention was made with government support under National Aeronautics and Space Administration contract NNX13AM99A. The government may have certain rights in the invention.

### FIELD OF THE INVENTION

This invention relates to metallic component which is a composite of at least two distinct metal alloy segments, and to a method for joining two distinct alloys.

### BACKGROUND

It is often desirable to join two metals or alloys together such as when surface properties of an exotic alloy are desirable in conjunction with strength or other properties of a more base metal, for example. Traditional metals joining techniques such as heat fusion welding are unsuitable for joining metallurgically incompatible metals. Traditional joining processes can result in the formation of undesirable intermetallics which can embrittle the joint between the two metals. In addition, residual stress and excessive generation of strains at the interface may arise from the thermal expansion difference of dissimilar alloys. All of the above negative factors can lead to failure during the joining process or ultimately result in corrosion fatigue failure during service.

Titanium and Ti series alloys have addressed a lot of concerns because they are considered some of the best engineering materials in the aerospace, nuclear, and chemical industries. They are known for their particular mechanical and metallurgical properties such as light weight, high strength-to-weight ratio, and superior heat resistance. In the aerospace industry, Ti alloy is a significant material of choice for

requiring a lightweight surface coupled with strong heat resistance. For example, Ti alloy in an atmosphere of 500° C. maintains very good strength and stability. Several kinds of aircraft, such as missiles and rockets, fly at super high speed so their engine and surface temperatures are quite high. In this working situation, the Ti alloy is more appropriate than other metal alloys with relatively weak heat resistances.

In order to combine good mechanical and metallurgical properties of Ti-based alloys, and either good formability or economic prices of other alloys, there is an upsurge of interest to join Ti alloys with dissimilar structural steels or stainless steels. It is well known that stainless steel is good for weldability and is much more economic than costly Ti alloys. Unfortunately, traditional heat fusion welding has not yet

been technically capable of joining Ti alloy with stainless steel because of a metallurgical incompatibility between them. Direct heat fusion welding of Ti alloy and stainless steel can result in the formation of a variety of intermetallic compounds such as TiFe, TiFe₂, and so on. These intermetallic compounds are brittle and can embrittle the joint. In addition, residual stress and excessive generation of strains at the interface may arise from the thermal expansion difference of dissimilar alloys. All of the above negative factors can lead to failure during the joining process or ultimately result in corrosion fatigue failure during service.

### SUMMARY OF THE INVENTION

Briefly, therefore, in one aspect the invention is directed to a method for joining a first alloy material to a second alloy material comprising forming a metallic interface therebetween. The metallic interface comprises a first layer directly on the first alloy and which comprises a first metallic element having high solubility with a major material element in the first layer, a second layer directly on the first layer and which comprises a second metallic element having a high solubility with the first metallic element, and a third layer directly on the second layer and which comprises a third metallic element having a high solubility with the second alloy material, wherein the third layer is in direct contact with the second alloy material.

In another aspect, the invention is directed to a method for joining a first alloy material to a second alloy material comprising a) forming a first interface layer directly on a substrate, wherein the substrate comprises the first alloy material, and the first interface layer consists essentially of metal material which does not form intermetallic compounds with elements in the first alloy material; b) forming a second interface layer directly on the first interface layer, wherein the second interface layer consists essentially of metal material which does not form intermetallic compounds with elements in the first interface layer metal material; c) forming a third interface layer directly on the second interface layer, wherein the third interface layer consists essentially of metal material which does not form intermetallic compounds with elements in the second interface layer metal material; and d) forming a layer of the second alloy material.

In another aspect, the invention is directed to a method for joining an Fe-based alloy material to a Ti-based alloy comprising forming a metallic interface therebetween. The metallic interface comprises a first layer directly on the Ti-based alloy and which consists essentially of metal material which does not form intermetallic compounds with with Ti, a second layer directly on the first layer and which consists essentially of metal material which does not form intermetallic compounds with elements in the first interface layer metal material, and a third layer directly on the second layer and which consists essentially of metal material which does not form intermetallic compounds with elements in the second interface layer metal material and does not form intermetallic compounds with Fe.

Other objects and features of the invention will be in part apparent and in part pointed out hereinafter.

### BRIEF DESCRIPTION OF THE FIGURES

FIG. 1 is a schematic illustration of one embodiment of the composite metallic component of the invention.

FIG. 2 is a schematic illustration of the process set-up for a preferred manufacturing method of the invention.

FIG. 3 is a photograph of a metallic composite of the invention mounted in plastic for metallography.

FIG. 4 is an energy dispersive spectrometry (EDS) plot of the composite of FIG. 3.

FIGS. 5 through 8 are scanning electron photomicrographs taken at selected locations on the composite of FIG. 3.

FIG. 9 is a series of X-Ray diffraction patterns on the composite of FIG. 3.

FIG. 10 is a hardness distribution plot of the composite of FIG. 3.

### DETAILED DESCRIPTION OF PREFERRED EMBODIMENTS

The current invention is based on the inventors' discovery that a novel filler metal route can be used to join incompatible metals by forming a functionally graded material (FGM). For example, in one embodiment, Ti-based alloys are joined to Fe-based materials such as stainless steel materials by forming a functionally graded material. In one aspect the invention involves discovery of an appropriate transition composition manifest as filler layers between incompatible metals such as Ti-based alloys and stainless steel or other Fe-based substrates which filler layers are specially formulated to prevent the formation of intermetallics.

The invention involves forming an appropriate interface between two incompatible metals, where the interface avoids the formation of undesirable intermetallics. In the preferred embodiment for joining a first alloy to a second alloy, the invention employs a three-layer interface between the alloys. Other embodiments employ a multi-layer interface of four or more layers, such as between four and seven layers. The first layer of the interface is directly on the first alloy (i.e., directly on the substrate) and consists essentially of metal material which does not form intermetallic compounds with elements in the first alloy substrate material. “Consists essentially of” in the context of this and other layers discussed herein means that there is only a very low tolerance for intermetallic-forming elements in the first interface metal material, such as no more than 0.2 wt %, such as no more than 0.1 wt %, cumulatively of elements that form intermetallic compounds with elements in the substrate alloy under the particular deposition parameters employed. Stated another way, “consists essentially of” here only tolerates such intermetallic-forming elements to the extent that such intermetallics are so rare in the eventual composite that they do not materially affect the integrity of the bond and interface between the two alloys joined together. This first interface layer metal material is highly soluble in the first alloy, such that the first interface layer is highly compatible with the first alloy layer and formation of intermetallics is avoided.

As a next step in transition to the second alloy layer, there is a second interface layer directly on the first interface layer. The second interface layer consists essentially of metal material which does not form intermetallic compounds with elements in the first interlayer metal material under the particular deposition parameters employed. Then there is a third interlayer directly on the second interlayer. This third interlayer consists essentially of metal material which does not form intermetallic compounds with elements in the second interlayer metal material under the particular deposition parameters employed.

In one currently preferred embodiment, this third interlayer material also consists essentially of metal material which does not form intermetallic compounds with elements in the second alloy surface layer under the particular deposition parameters employed. In this embodiment, the second alloy surface layer is formed directly on the third interlayer. The final structure in this embodiment therefore comprises a first alloy substrate, and a second alloy surface layer, with three interface layers therebetween.

The two main bulk structural components are the first alloy substrate and the second alloy surface layer. The thickness and other dimensions of these two components are not narrowly critical to the invention, and are dictated by the application for which the final composite component is intended. For example, in many embodiments the thickness of the second alloy surface layer is more than 5 mm. The thickness of each of the interface layers in one preferred embodiment is between about 0.5 and 2 mm, such as between about 0.75 and 1.5 mm. The overall transition zone of three interface layers is therefore between about 1.5 and about 6 mm, such as between about 2.25 and 4.5 mm.

In other embodiments, there are more than three interlayers, such as from four up to about eight interlayers. Each interlayer consists essentially of metal material which does not form intermetallic compounds with elements in the previous and subsequent layers.

In making the composite component of the invention the overall process involves joining a first alloy material to a second alloy material where the two alloys are generally incompatible. A first step is to form a first interface layer directly on a substrate, wherein the substrate comprises, or consists of, the first alloy material. The first interface layer consists essentially of metal material which does not form intermetallic compounds with elements in the first alloy material. For example, in one embodiment, the first alloy material is Ti6Al4V and the second alloy material is SS316, two materials which are incompatible for the reasons discussed above. In this case, a first interface layer is formed directly on a substrate of the Ti6Al4V alloy. This interface layer comprises a metallic element that has a high solubility with the Ti6Al4V alloy. In the preferred embodiment, this metallic element is V, which does not form intermetallic compounds with elements from Ti6Al4V. In one preferred embodiment, the first interface layer material consists essentially of a single element metal (e.g., V, not an alloy).

A preferred method for forming the first interface layer as well as subsequent layers is one of several available metal additive manufacturing processes. The additive process selected must be one that is compatible with the metal material being deposited and the substrate. And the process must deposit the respective layers in a manner which does not result in the formation of intermetallic compounds. Whether elements in a layer being deposited form intermetallics with elements in the substrate or lower layer is a function of chemistry as well as processing. Some chemical composition combinations will not form intermetallics under any practical deposition conditions. Whereas other chemical composition combinations will form intermetallics under some conditions, but not under others. So depending on the selected metal materials, it may be more important to use, for example, a rapid cooling process that inhibits the formation of intermetallics. Among preferred additive manufacturing processes for use in this invention are directed energy deposition (DED) processes such as wirefeed additive manufacturing or powder-based methods such as laser metal deposition (LMD) and electron beam manufacturing (EBM). Other processes such as selective laser melting (SLM) and direct metal laser sintering are not excluded, provided they are controlled such that intermetallics do not form. Laser metal deposition (LMD), for example, is an advanced additive manufacturing technology which can directly produce fully dense, functional metal parts. In its operation, a laser beam is focused on a metallic substrate to create a melt pool. A powder stream is continuously conveyed into the melt pool by the powder delivery system. Advantages of LMD germane to the present invention included high energy density, precise and flexible heating position, and laser beam radius. In this method, the heat-affected zone can be controlled to a small size, and the process can be completed in a short time period. A substrate is attached to a computer numerical control (CNC) multi-axis system. By moving the substrate according to a desired route pattern, a 2D layer can be deposited. Then, a 3D object can be formed through building successive layers on top of one another.

A subsequent step in the process is forming a second interface layer directly on the first interface layer. The second interface layer consists essentially of metal material which does not form intermetallic compounds with elements in the first interface layer metal material. For example, in one embodiment, where the first interface layer is a V-based layer formed directly on a Ti6Al4V alloy substrate, this interface layer comprises a metallic element that has a high solubility with the V-based layer. In the preferred embodiment, this metallic element is Cr. In one preferred embodiment, the second interface layer material consists essentially of a single element metal (e.g., Cr, not an alloy).

Then a third interface layer is formed directly on the second interface layer. The third interface layer consists essentially of metal material which does not form intermetallic compounds with elements in the second interface layer metal material. This third interface layer also consists essentially of metal material which does not form intermetallic compounds with elements in the subsequent layer. This subsequent layer in one preferred embodiment is the second alloy material which forms one of the two main bulk structural elements of the overall composite. For example, in one embodiment, where the first interface layer is a V-based layer formed directly on a Ti6Al4V alloy substrate, and the second interface layer is a Cr-based layer, this third interface layer consists essentially of metal material that does not form intermetallic compounds with the Cr-based second interface layer. In one currently preferred embodiment, this third interface layer consists essentially of Fe. This Fe also has a high solubility with the second alloy material, which in this preferred embodiment is SS316. In one preferred embodiment, the third interface layer material consists essentially of a single element (e.g., Fe).

The next step in the process is to attach the second bulk structural element to the substrate, using the multi-layer (e.g., three-layer) interface between the second bulk structural element and the first bulk structural element (i.e., the substrate). This attachment can be performed in various ways; but in a preferred embodiment it is performed by LMD, in the same manner that the three or more interface layers are formed. In one preferred embodiment, therefore, a SS316 powder is deposited by LMD over the third interface layer.

In the case of joining stainless steel and Ti-based alloys, V was first considered as a suitable transition metal since V exhibits an excellent solubility with Ti in the Ti—V binary system. The beta-phase Ti forms a complete range of solid solutions with V, whereas the behavior of alpha-phase Ti is more limited in this respect. These promising properties of V as a transition metal are further enhanced by thermal expansion coefficients which form a ratio (Ti:V) of 8.5:8.3. Chromium (Cr) is another candidate metal as an adjacent transition material after V since V and Cr exhibit unlimited mutual solid solubility across the entire V—Cr binary system. That is, as shown in the binary alloy phase diagram for the V—Cr system, V and Cr exhibit unlimited mutual solid solubility across the entire system beneath the solidus. So Cr is a candidate metal as an adjacent transition material in a currently preferred embodiment. Iron is especially compatible with stainless steel. In the Fe—Cr binary alloy system, a pure sigma phase exists between 472° C. and 830° C. if the mass percentage of Cr is greater than 42.7 wt % and less than approximately 48.2 wt %, as shown in a binary alloy phase diagram for the Fe—Cr system. Also, there is no sigma phase precipitation beneath 472° C. and close to room temperature. The sigma phase is often precipitated under an elevated temperature environment, such as casting, rolling, welding, forging, and aging. So as a final interface phase in one preferred functionally graded material of the invention, Fe is used between Cr and the stainless steel (e.g., SS316) substrate.

The cooling rate in LMD/laser blown powder deposition is always greater than 1° C./s, such as greater than 7° C./s, and often greater than 10° C./s, so the sigma phase can be avoided using this joining technique, provided appropriate metals are used. And, in particular, the inventors have discovered that a transition route involving Ti6Al4V—V—Cr—Fe-SS316 can effectively control the intermetallic formation if the joining is performed by a process with a sufficiently high cooling rate, such as laser blown powder deposition/laser metal deposition (LMD). A Ti-based alloy/stainless steel composite with this transition route can effectively eliminate the intermetallic phase formation. Accordingly, it will be understood that avoiding the formation of intermetallic phases can be driven by process selection as well as by composition. The preferred embodiment uses LMD because of its rapid cooling rate that helps avoid the formation of intermetallic phases. But lower cooling rate process can be used, instead, so long as the respective compositions consist essentially of metal material that does not form intermetallics with elements in adjacent layers under the lower cooling rate.

### COMPARATIVE EXAMPLE

Stainless steel metallic powder was directly deposited on the titanium alloy substrate by laser beam. As expected, Ti—Fe intermetallic phases formed in this process. These were investigated through analyzing fracture morphology, phase identification, and Vickers Hardness Number (VHN). Substantial cracking occurred when SS316 was directly deposited on Ti6Al4V and contributed to a large amount of intermetallic phase. This demonstrated that laser direct deposition to join titanium alloy and stainless steel is hindered by the formation of interfacial intermetallics caused by metallurgical reactions, especially Ti—Fe intermetallics. To investigate the Ti—Fe intermetallics in the process of laser deposition, SS316 metallic powder was deposited on Ti6Al4V substrate directly by fiber laser, then analyzed fracture morphology, phase identification, and Vickers Hardness Number (VHN). The LMD operating parameters were 550 Watts, 2 mm beam diameter, 200 mm/minute scan speed, argon as shielding gas, and powder feed rate of 7.2 grams/minute.

The stainless steel layer fell off the Ti-based substrate coupled with clear cracking sound. The morphology in the fracture area was relatively smooth, indicating the fracture mechanism is classic cleavage fracture, caused by disruption surfaces separating along a crystal plane. Cleavage fracture happens in body-centered cubic (BCC) and hexagonal close-packed (HCP) metal or alloy. Its crack-evolution is very fast resulting in metallic component collapse. This phenomenon indicates that the phase formed in the fracture area is very hard and brittle, and almost without any plasticity. An XRD test was performed on the fracture area to identify the formed phase. This test showed that the main intermetallic phases were Fe₂Ti and FeTi. The brittleness and hardness of these two caused the direct fracture and clear cracking sound under thermal stress and excessive generation of strains at the interface arising from the thermal expansion difference of Ti-based and stainless steel alloys.

Vickers hardness tests were conducted from the Ti6Al4V side to the SS316 side of the interface. The VHN near the crack region was much greater than in the region of the base alloys on both sides remote from the crack. This corresponds to poor plasticity in the crack region. The crack therefore can generate under the action of relatively small thermal stress. These hardness tests illustrate that the formation of intermetallic phases is the primary cause for the failure when directly laser depositing stainless steel powder on Ti-based alloy substrate.

### INVENTION EXAMPLE 1

A sample of Ti-based alloy Ti6Al4V was joined to a sample of Fe-based SS316 using the process and interface of the invention. A challenge in developing an interface between these two materials is that there is no element that by itself would work well with both sides of an interface between a Ti-based alloy and Fe-based stainless steel. The elements that are highly soluble with Ti will generate intermetallic phases with Fe because of their limited solubility with Fe; and the elements that are highly soluble with Ti will generate intermetallic phases with Fe because of their limited solubility with Fe.

Accordingly, materials used in the embodiment of the invention manifest in this working example were Ti6Al4V, SS316, V, Cr, and Fe. Ti6Al4V and SS316 were regarded as the target materials since the objective was to join these two materials. V, Cr, and Fe were used as filler composition that transitions from Ti6Al4V to SS316 successively. The chemical compositions of Ti6Al4V and SS316 were as follows:

### Chemical Composition of the Target Materials (wt %)

| Materials | C | Mn | Si | P | H | S | Cr | Al | V | Mo | O | Ni | N | Fe | Ti |
|---|---|---|---|---|---|---|---|---|---|---|---|---|---|---|---|
| Ti6Al4V | 0.08 | — | — | — | 0.025 | — | — | 6.76 | 4.5 | — | 0.2 | — | — | 0.25 | Balance |
| SS316 | 0.03 | 2 | 0.75 | 0.045 | — | 0.03 | 18 | — | — | 3 | — | 14 | 0.1 | Balance | — |

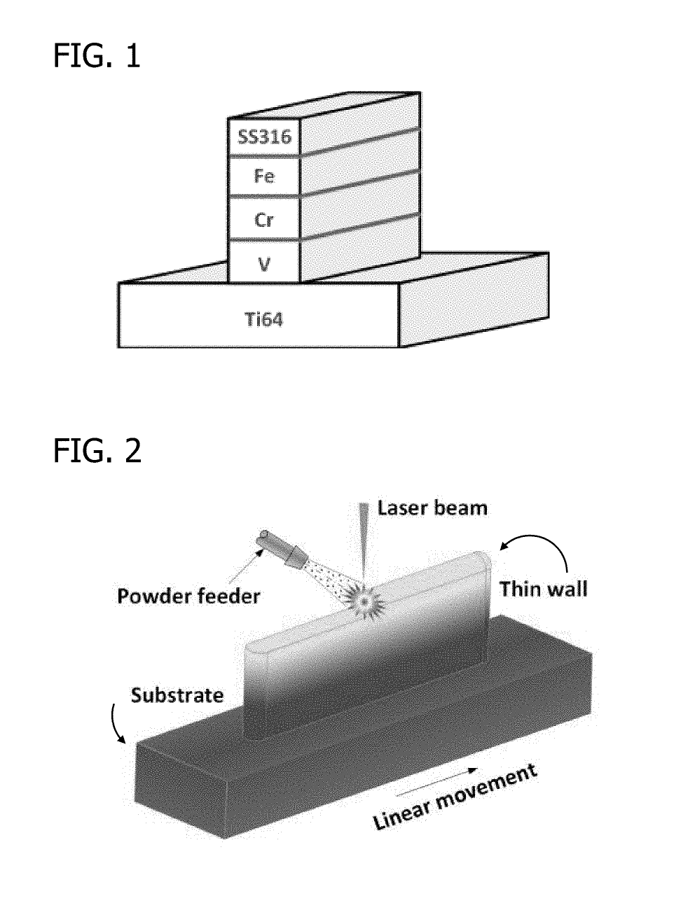

The V, Cr, Fe, and SS316 were in the form of pure powder. The Ti6Al4V substrate was prepared in the form of a 2×0.5×0.25 in bar. A Ti6Al4V bar was used as a substrate for deposition of powders by laser metal deposition. The powders of V, Cr, Fe, and SS316 were deposited on the top surface of the Ti6Al4V bar successively. The composition route is shown in FIG. 1.

The powders used in this example were characterized to analyze particle shape and size distribution. The quality of deposits could be potentially correlated with particle size and shape, so size distribution and particle shape were analyzed. Microscope images were taken by SEM equipment (Hitachi S4700). The particles size distributions for all the four types of powder were displayed by the sieve analysis were as follows:

### Sieve Analysis of V, Cr, Fe, and SS316 Powder

| Sieve type | 70 mesh | 100 mesh | 120 mesh | 140 mesh | 200 mesh | 325 mesh |
|---|---|---|---|---|---|---|
| Size (μm) | >212 | 150-212 | 125-150 | 106-125 | 75-106 | 45-75 |
| Percentage (%).V | 1.3 | 4.0 | 8.4, | 23.7 | 27.4 | 35.2 |
| Percentage (%).Cr | 0.0 | 0.6 | 5.9 | 9.3 | 12.7 | 71.5 |
| Percentage (%).Fe | 3.1 | 9.2 | 22.4 | 35.1 | 21.8 | 8.4 |
| Percentage (%).SS316 | 0.0 | 0.3 | 3.8 | 9.0 | 48.2 | 38.7 |

In this study, the laser metal powder deposition set-up includes a laser system which provides the heat source, a powder feeding system with a ceramic nozzle, and a CNC table. For the laser heat source, a continuous wave (CW) fiber laser system with a 1.064 μm wavelength was used. The laser system can provide at most 1000 W laser output power. The laser energy intensity was in accordance with Gaussian distribution. The optics in the laser beam delivery system provides a beam diameter of 2 mm in this experiment.

The powder feeding system had a powder container and a gas carrying pipeline system. Inert argon was used as a carrying gas to move the powder from the powder container through the pipeline system. The flowing Ar carrying the metal powder was sprayed through an Al₂O₃ ceramic nozzle so that the metal powder reached the melt pool area.

The CNC table was used to generate the displacement of the substrate in a horizontal direction and the displacement of the laser beam delivery system in a vertical direction so that the laser deposition path could be created.

The laser metal powder deposition procedure is depicted in FIG. 2. A 3-dimensional thin wall sample was fabricated layer by layer with different metal powders deposited on the surface of a moving Ti6Al4V substrate. In order to observe the property of the different powders at different layers conveniently, the sample was fabricated in the form of a thin wall structure. Three successive interface layers of V, Cr, and Fe were deposited followed by a SS316 layer with laser processing parameters of argon shielding gas, 200 mm/minute scan speed, and 2 mm beam diameter for all four layers. The V layer was deposited to about 1.25 mm thickness; the Cr and Fe layers were each deposited to about 1 mm thickness; and the SS316 layer was deposited to about 4 mm thickness. The output power was 1000 watts for the V and Cr layers, 700 watts for the Fe layer, and 550 watts for the SS316 layer. Since solidus temperatures for the candidate materials are different, various heat energy inputs were needed to melt the metal powder in LMD, in order to keep the shape of the thin wall uniform and rectangular.

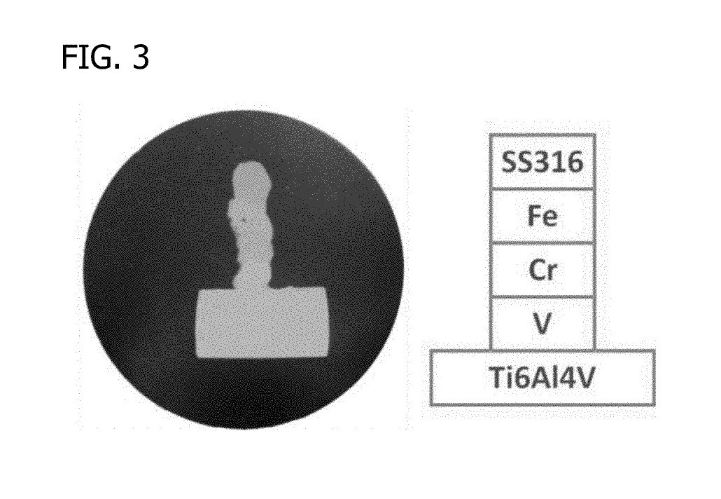

A specimen was cut off of the thin wall sample using the Hansvedt Electric Discharge Machine (EDM). The specimen was then mounted on mounting pressure equipment (Simplimet 1000) using a phenolic resin powder. Then, the offcut cutting surface was grinded using abrasive papers from 180 Silicon Carbide Grit to 1200 Silicon Carbide Grit. After that, the specimen was polished using colloidal silica with a median particle size of 0.05 μm. The final prepared specimen is shown in FIG. 3.

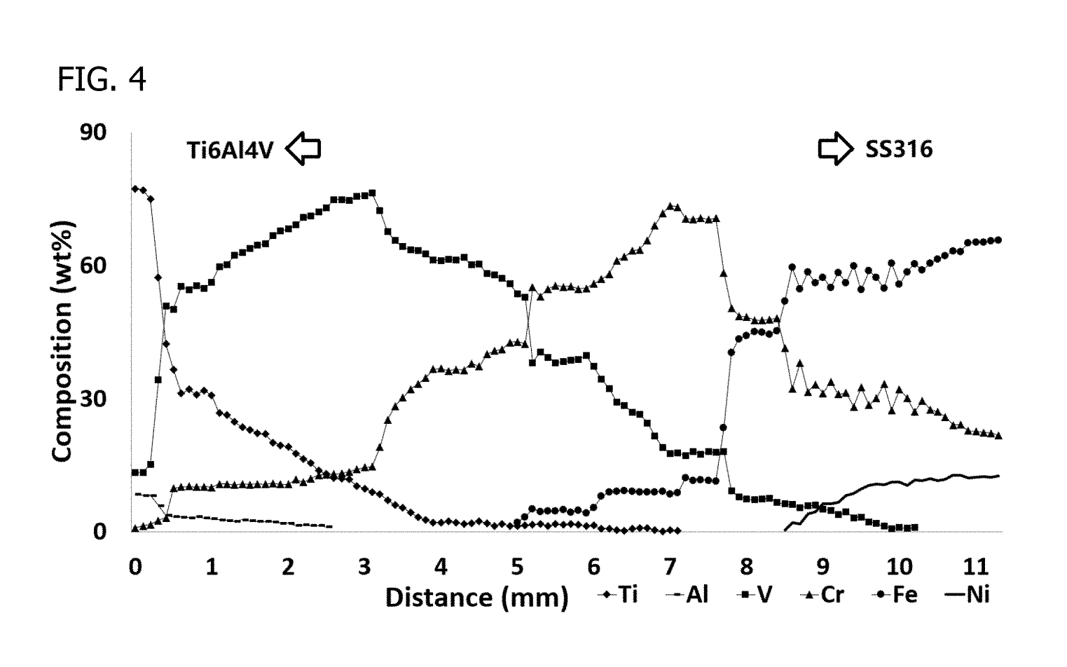

Energy dispersive spectrometry (EDS) was used to analyze the element concentration distribution across the transition zone between the Ti-based substrate and Fe-based (stainless steel) top layer. The analyses were performed on Helios NanoLab 600 coupled with an Oxford EDS extension. One hundred fifteen sample points were uniformly distributed across the zone, beginning at the Ti-based substrate. The interval between two adjacent points was 0.1 mm, with a dwell time for each point of 5 s. The EDS point test data is plotted in FIG. 4. The element distribution curves along the transition composition route on the specimen surface show features such as intersection, immediate lift and dip, and stagger up and down. These kinds of phenomenon can demonstrate the clear element concentration tendency along the transition composition. Three ridges indicate three transition metals: V, Cr, Fe. Vanadium and Cr can diffuse to other metal layers easily. Element diffusion is due to multiple heating and a high temperature gradient in the LMD deposition.

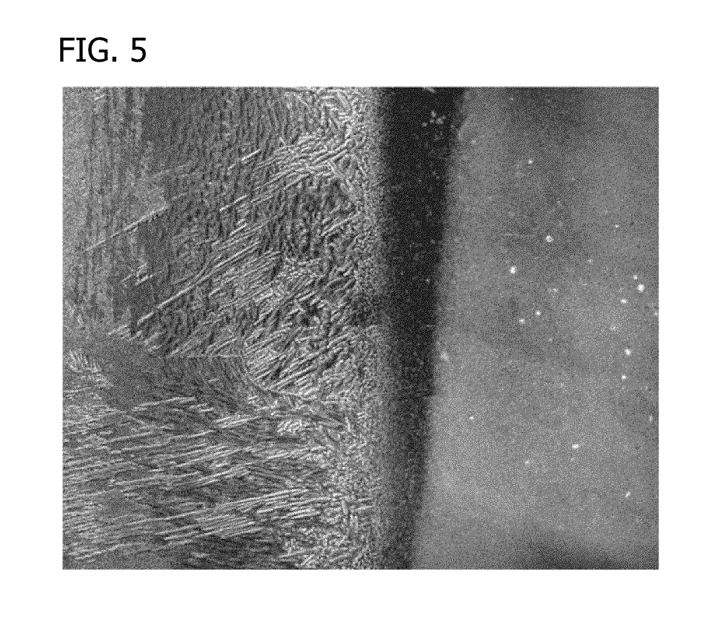

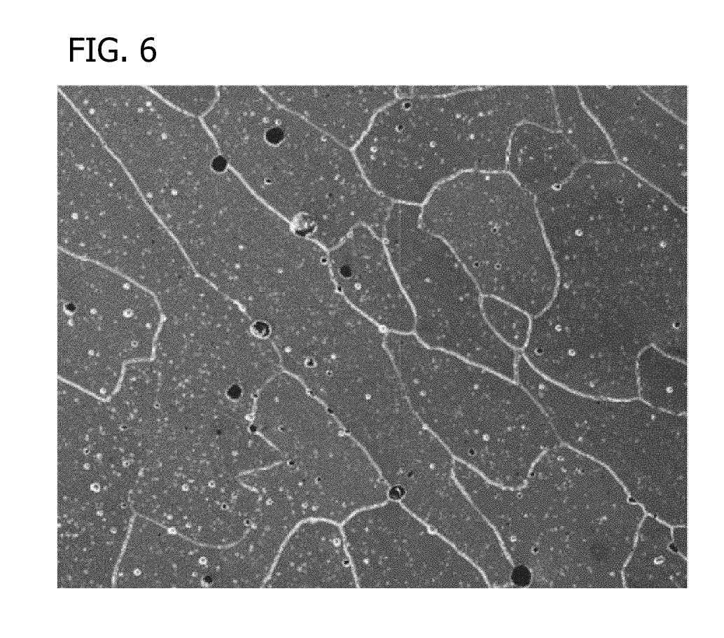

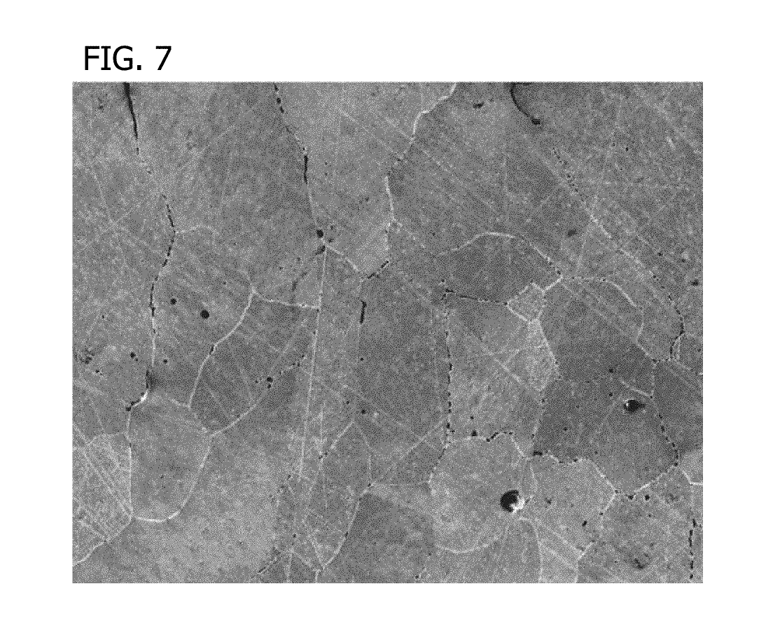

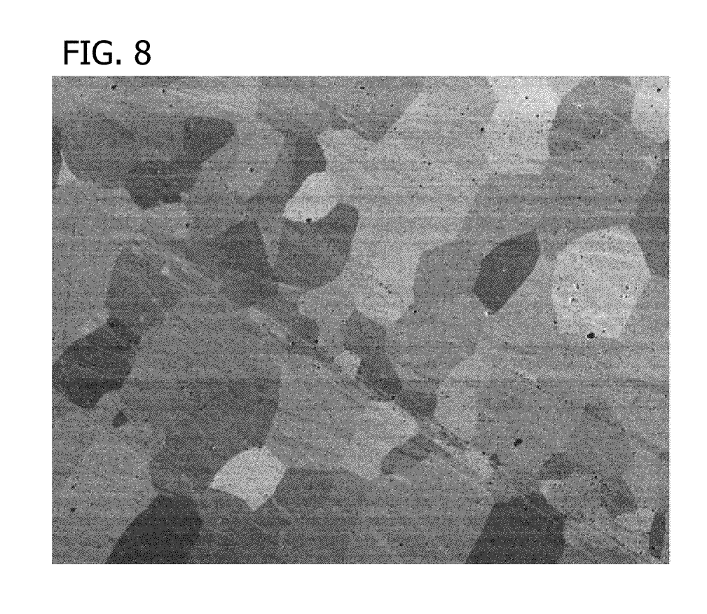

To observe the microstructure, four sample sites were selected across the transition, whose positions were determined by the maximum weight percentage of Ti, V, Cr, Fe based on the EDS point test in FIG. 4. SEM tests were performed on the four selected sites. FIG. 5 (350× magnification) depicts the microstructure close to the Ti6Al4V substrate, where Ti concentration is highest. The interface between substrate and V layer is evident. On the left side of interface, the Ti6Al4V region exhibits an elongated lamellar-type microstructure. This is expected because the substrate surface is completely melted and re-solidified during LMD process and undergoes rapid solidification. High cooling rate causes this type of microstructure. Closer to the interface, the microstructure is thinner and smaller. From the interface to the Ti6Al4V, the grain's epitaxial growth in solidification can be seen. On the right side of interface, close to V region, some pores are observed which formed in the LMD process. FIG. 6 (500× magnification) depicts the microstructure with maximum V concentration. The microscopic image exhibits an equiaxed microstructure. Due to the high cooling rate in rapid solidification, the equiaxed microstructure is elongated approximately along the cooling direction. It can be noticed that gas porosity occurred in V layer. FIG. 7 (250× magnification) depicts the microstructure in the region with highest Cr concentration. An equiaxed-type microstructure is observed in this region. Rapid solidification results in the elongated microstructure. Gas porosity is again found in the Cr-rich layer. FIG. 8 (250× magnification) depicts the microstructure where Fe concentration is highest. In this region the microstructure exhibits a classic ferrite equiaxed grain. Some tiny gas pores can be found in some area.

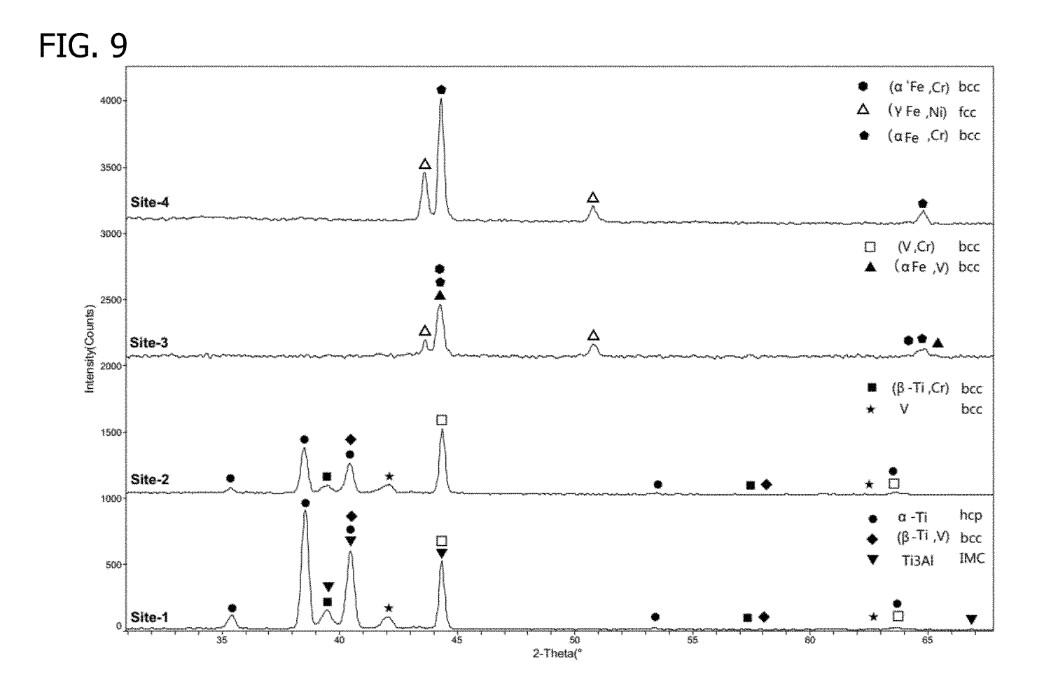

X-ray diffraction tests were used to identify the phases on each site. The XRD tests were operated with XPERT Pro-type diffractometer. The anode material was Cu. All the XRD patterns on four sites, determined by the maximum weight percentage of Ti, V, Cr, Fe, are shown in FIG. 9. These four XRD patterns demonstrate a gradual transition from Ti6Al4V to SS316.

On the first site, a circular dot is used to represent α-Ti. Diamond indicates β-Ti. Inverted triangle indicates Ti3Al. All of them are the primary phases in Ti6Al4V. In addition, the (V, Cr) solid solution has strong intensity. Another β-Ti with bcc structure can be detected. It is the solid solution between Ti and Cr. Multiple heating and a high temperature gradient in LMD cause Cr diffusion in the V layer and even near the Ti6Al4V. Diffused Cr forms into solid solution with V and Ti, respectively. Some bcc peaks are lost in the XRD pattern. It is mainly caused by a preferred orientation or texture. When the specimen is prepared for XRD test, grinding and polishing may cause the multi crystal's grain directions to be oriented. The XRD pattern on site-2 is similar with site-1. The intensity of α-Ti and β-Ti is weakening, but still obvious. The intensity of (V, Cr) is stronger than site-1. The reason should be the higher concentrations of Cr and V on site-2. On the site-3, the α-Ti and β-Ti are not detected. The intensities of (αFe, V) and (αFe, Cr) keep increasing. (αFe, V) is bcc solid solution of Fe and diffused V. (αFe, Cr) is the solid solution of Fe and Cr, which is also called ferrite with bcc structure. Austenitic fcc solid solution (γFe, Ni) is detected. This austenite phase may be in the SS316 layer, just detected by larger XRD sample area. There are two kinds of Fe—Cr solid solutions α and α′. The (α′Fe, Cr) is high concentration Cr bcc, while (αFe, Cr) is low concentration Cr bcc. Both of them precipitate from the segregation of ferritic solid solution α(δ). In the XRD pattern on site-4, the ferrite bcc has strong intensity. Austenite (γFe, Ni) fcc can also be detected. The XRD pattern on site-4 is close to what is expected for SS316.

From site-1 to site-3, α-Ti and β-Ti decrease and disappear. On the other hand, ferrite and austenite start to appear from site-3, and increase to the major phases on site-4. Since V, Cr and Fe are added as intermediate metal, some solid solutions are detected in the transition layers. The XRD patterns can verify the material transition design from Ti6Al4V to SS316. In addition, the XRD patterns on the four sites indicate that there is not intermetallic phase. Therefore, XRD analysis demonstrates that the intermetallic phases are effectively eliminated using the composition and process of the invention.

Generally, hardness is an important material property that can indicate the resistance to plastic deformation by penetration. The Vickers hardness test applies an inverted diamond pyramid as an indenter. It is adapted for micro hardness testing for various materials such as metals, alloys, ceramics, composites, etc. In the present context, the micro hardness of the intermetallic phase is far greater than of the pure metal and alloy in the composition route. Therefore, the Vickers hardness test is useful to locate the possible formation of the intermetallic phase.

The thin wall sample prepared as described above was cut transversely by the wire electrical discharge machine (Hansvedt DS-2 Traveling Wire EDM) to acquire the cross section. Thirty Vickers hardness sampling points were taken along the interface to cover all the candidate materials. The cut sample was pressed into the mounting material in order to fit the Vickers hardness tester conveniently. The sample preparation is shown in FIG. 3. The Vickers hardness test was performed at room temperature using a Struers Duramin-5 hardness tester with a press load of 9.81 N and load time of 10 s. Indentions started at the SS316 edge and continued at various spacing into the Ti6Al4V substrate region.

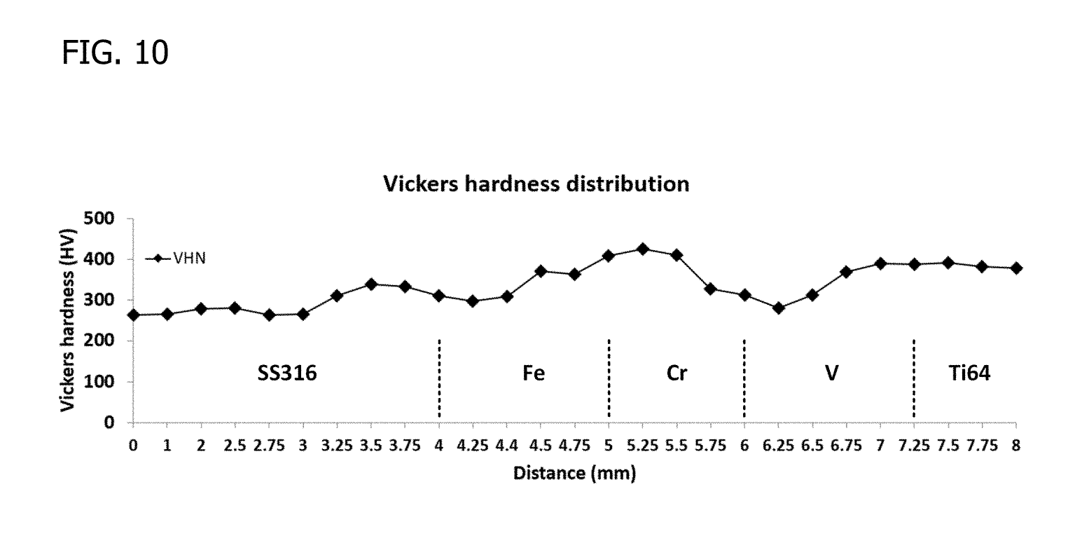

FIG. 10 shows the Vickers hardness test values along with indications of what material region these values belong to. The hardness values were stabilized throughout the SS316 region at 281±19 HV. The highest hardness values were observed around the Fe—Cr interface followed by a slight decrease in hardness value at the Cr—V interface, and then a slight increase in hardness value at the Fe—V interface. The subsequent increase in the Ti6Al4V region was stabilized at 375±16 HV. In the total Vickers hardness number (VHN) distribution, the maximum hardness value was 425.3 HV. There is no obvious volume of high VHN areas in the distribution. All the VHN gradients were slight instead of steep changes. The Vickers hardness test result on the sample reveals that there is no significant formation of intermetallic phase if the transition composition route is utilized.

From the foregoing it can be seen that by the process of LMD, specific filler materials can be used to form a functionally graded material effectively joining a Ti-based alloy to an Fe-based alloy such as stainless steel alloy. In the embodiment depicted here, Ti6Al4V is joined to SS316 with V as the first layer of deposit, then Cr, Fe, and SS316 as the final layer.

In view of the above, it will be seen that the several objects of the invention are achieved and other advantageous results attained.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above compositions and methods without departing from the scope of the invention, it is intended that all matter contained in the above description and shown in the accompanying drawings shall be interpreted as illustrative and not in a limiting sense.

1. A method for joining a second alloy material to a first alloy material comprising:
forming a first interface layer directly on a substrate, wherein the substrate comprises the first alloy material, and the first interface layer consists essentially of metal material which does not form intermetallic compounds with elements in the first alloy material;
forming a second interface layer directly on the first interface layer, wherein the second interface layer consists essentially of metal material which does not form intermetallic compounds with elements in the first interface layer metal material;
forming a third interface layer directly on the second interface layer, wherein the third interface layer consists essentially of metal material which does not form intermetallic compounds with elements in the second interface layer metal material; and
forming a layer of the second alloy material over the third interface layer.

2. The method of claim 1 wherein:
the forming the layer of the second alloy material over the third interface layer comprises forming the layer of the second alloy material directly on the third interface layer; and
the third interface layer consists essentially of metal material which does not form intermetallic compounds with elements in the second alloy material.

3. The method of claim 1 further comprising forming one or more additional interface layers over the third interface layer prior to forming the layer of the second alloy material.

4. The method of claim 1 further comprising:
forming a fourth interface layer directly on the third interface layer;
wherein the forming the layer of the second alloy material over the third interface layer comprises forming the layer of the second alloy material directly on the fourth interface layer; and
the fourth interface layer consists essentially of metal material which does not form intermetallic compounds with elements in the third interface layer and does not form intermetallic compounds with elements in the second alloy material.

5. The method of claim 1 wherein each of the interface layers has thickness between about 0.5 and about 2 mm.

6. The method of claim 1 wherein each of the interface layers has thickness between about 0.75 and about 1.5 mm.

7. The method of claim 1 wherein the forming the first, second, and third interface layers is performed by laser metal deposition with a cooling rate of greater than 7° C.

8. The method of claim 7 wherein the forming the second alloy layer is performed by laser metal deposition with a cooling rate of greater than 7° C.

9. The method of claim 1 wherein the second alloy material is an Fe-based material and the first alloy material is a Ti-based material.

10. The method of claim 1 wherein the second alloy material is stainless steel and the first alloy material is Ti6Al4V alloy.

11. The method of claim 1 wherein:
the substrate comprises Ti6Al4V alloy;
the first interface metal material consists essentially of V;
the second interface metal material consists essentially of Cr;
the third interface metal material consists essentially of Fe;
the second alloy material comprises stainless steel.

12. The method of claim 1 wherein:
the substrate comprises Ti6Al4V alloy;
the first interface metal material consists essentially of V;
the second interface metal material consists essentially of Cr;
the third interface metal material consists essentially of Fe;
the second alloy material comprises stainless steel;
the forming the layer of the second alloy material over the third interface layer comprises forming a layer of the stainless steel directly on the third interface layer.

13. The method of claim 1 wherein:
the substrate comprises Ti6Al4V alloy;
the first interface layer has a thickness from about 0.5 to about 2 mm and the first interface metal material consists essentially of V;
the second interface layer has a thickness from about 0.5 to about 2 mm and the second interface metal material consists essentially of Cr;
the third interface layer has a thickness from about 0.5 to about 2 mm and the third interface metal material consists essentially of Fe;
the second alloy layer has a thickness greater than 5 mm and the second alloy material comprises stainless steel.

14. The method of claim 1 wherein:
the substrate comprises Ti6Al4V alloy;
the first interface layer has a thickness from about 0.5 to about 2 mm and the first interface metal material consists essentially of V;
the second interface layer has a thickness from about 0.5 to about 2 mm and the second interface metal material consists essentially of Cr;
the third interface layer has a thickness from about 0.5 to about 2 mm and the third interface metal material consists essentially of Fe;
the second alloy layer has a thickness greater than 5 mm and the second alloy material comprises stainless steel;
the forming the layer of the second alloy material over the third interface layer comprises forming a layer of the stainless steel directly on the third interface layer.

15. The method of claim 1 wherein:
the substrate comprises Ti6Al4V alloy;
the first interface layer has a thickness from about 0.5 to about 2 mm and the first interface metal material consists essentially of V;
the second interface layer has a thickness from about 0.5 to about 2 mm and the second interface metal material consists essentially of Cr;
the third interface layer has a thickness from about 0.5 to about 2 mm and the third interface metal material consists essentially of Fe;
the second alloy layer has a thickness greater than 5 mm and the second alloy material comprises stainless steel;
the forming the layer of the second alloy material over the third interface layer comprises forming a layer of the stainless steel directly on the third interface layer;
the forming of each respective layer is performed by laser metal deposition with a cooling rate of greater than 7° C./second.
